(19) United States
(12) Patent Application Publication
(10) Pub. No.: US 2014/0354697 A1
(43) Pub. Date: Dec. 4, 2014

(54) ANALOG INTERFEROMETRIC MODULATOR COLOR CALIBRATION

(71) Applicant: QUALCOMM MEMS Technologies, Inc., San Diego, CA (US)

(72) Inventor: Denis H Endisch, San Diego, CA (US)

(73) Assignee: QUALCOMM MEMS Technologies, Inc., San Diego, CA (US)

(21) Appl. No.: 13/905,518

(22) Filed: May 30, 2013

(51) Int. Cl. H04N 17/02; G09G 5/04; G01N 21/27

(52) U.S. Cl. CPC H04N 17/02; G01N 21/274; G09G 5/04
USPC 345/690; 356/402; 356/405; 356/408

(57) ABSTRACT

This disclosure provides systems, methods and apparatus for calibration of analog display elements such as analog interferometric modulators (IMODs). In one aspect, display devices include both a light-turning layer and integrated color sensor in order to provide feedback on the operation of the display. In particular, the integrated color sensors can be used to determine a relative shift in a color signal output by an analog display element.

### TECHNICAL FIELD

This disclosure relates to methods of measuring and calibrating analog display elements configured to output a range of colors.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

The properties of display elements, including EMS display elements such as IMOD display elements, can vary based on both current operating conditions, such as temperature, and based on changes to the display element over time which occur as the display element ages. Without measurement of the output of the display element, and possible recalibration of the display element, the actual color output from a display element can be significantly different from the intended color.

### SUMMARY

The systems, methods and devices of this disclosure each have several innovative aspects, no single one of which is solely responsible for the desirable attributes disclosed herein.

One innovative aspect of the subject matter described in this disclosure can be implemented in a device, including a display including at least one analog display element, where the analog display element is configured to output light of one of a plurality of discrete colors in response to the application of one of a plurality of driving conditions, a light-turning layer overlying the display, where the light-turning layer is configured to redirect a portion of output light reflected or emitted by the display into the light-turning layer, and a color sensor in optical communication with the light-turning layer.

In some implementations, the device can further include driver circuitry configured to apply at least a first driving condition to the analog display element, where the first driving condition is intended to cause the at least one display element to output a first color. In some implementations, the device can include measurement circuitry configured to analyze at least a signal measured from the color sensor during application of the first driving condition to the at least one display element to provide an indication of the actual color output by the at least one display element, and adjust the first driving condition if the actual color output by the at least one display element is different from the first color. In some implementations, the driver circuitry can be further configured to apply a second driving condition to the analog display element, where the second driving condition is intended to cause the at least one display element to output a reference color, and where the reference color remains substantially constant over the lifetime of the analog display element, and the measurement circuitry can be configured to analyze a second signal measured from the color sensor during application of the second driving condition to the at least one display element to provide an indication of the effect of ambient lighting conditions on the signals measured by the color sensor.

In one aspect, the analog display element can include an analog interferometric modulator (AIMOD), the AIMOD including a reflective layer spaced apart from an absorber layer by a distance which can be varied through application of the plurality of discrete driving conditions, and where a color of light reflected by the AIMOD is dependent upon the distance between the reflective layer and the absorber layer. In some implementations, the analog display element can be a reflective display element. In some implementations, the device can further include a light source in optical communication with the light-turning layer, the light source cooperating with the light-turning layer to form a frontlight system.

In some implementations, the color sensor can include at least one colorimeter in optical communication with the light-turning layer. In some implementations, the color sensor can include at least one group of photodiodes in optical communication with the light-turning layer, where the group of photodiodes includes a first photodiode, where light incident upon the first photodiode passes through a red filter, a second photodiode, where light incident upon the second photodiode passes through a green filter, and a third photodiode, where light incident upon the third photodiode passes through a blue filter. In some implementations, the color sensor can include thin film circuitry formed on the same side of a supporting substrate as the at least one analog display element.

In some implementations, the device can further include a processor that is configured to communicate with the display, the processor being configured to process image data, and a memory device that is configured to communicate with the processor. In some implementations, the device can further include a driver circuit configured to send at least one signal to the display, and a controller configured to send at least a portion of the image data to the driver circuit. In some implementations, the device can further include an image source module configured to send the image data to the processor, where the image source module includes at least one of a receiver, transceiver, and transmitter. In some implementations, the device can further include an input device configured to receive input data and to communicate the input data to the processor.

Another innovative aspect of the subject matter described in this disclosure can be implemented in a method of sensing an output of a display device, including applying a first driving condition to an analog display element, where the analog display element is intended to output light of a first color in response to application of the first driving condition, and where at least a portion of the output light passes through a light-turning layer configured to turn at least a portion of the output light passing therethrough into the light-turning layer, measuring a signal indicative of the color of light incident upon at least one color sensor, where the at least one color sensor is in optical communication with the light-turning layer, and comparing the measured signal to a second signal to provide an indication of whether an actual color output by the at least one display element in response to the first driving condition is different from the first color.

In some implementations, the method can further include illuminating the at least one analog display element during application of the first driving condition and measurement of the signal. In one aspect, the method can further include recalibrating the first driving condition based on the comparison between the measured signal and the second signal, where the second signal corresponds to an intended output light of the analog display element. In some implementations, the method can further include applying a second driving condition to the analog display element, where the second driving condition is configured to place the analog display element in a reference state in which the analog display element outputs a reference color which remains substantially constant over the lifetime of the analog display element, and measuring a reference signal indicative of the color of light incident upon the at least one color sensor during application of the second driving condition to provide an indication of the effect of ambient lighting conditions on the signals measured by the color sensor.

Another innovative aspect of the subject matter described in this disclosure can be implemented in a non-transitory, computer-readable storage medium having instructions stored thereon that cause a processing circuit to perform a method including applying a first driving condition to an analog display element of a display device, where the analog display element is intended to output light of a first color in response to application of the first driving condition, and where at least a portion of the output light passes through a light-turning layer of the display device configured to turn at least a portion of the output light passing therethrough into the light-turning layer, measuring a signal indicative of the color of light incident upon at least one color sensor of the display device, where the at least one color sensor is in optical communication with the light-turning layer, and comparing the measured signal to a second signal to provide an indication of whether an actual color output by the at least one display element in response to the first driving condition is different from the first color.

In some implementations, the computer-readable storage medium can further include recalibrating the first driving condition based on the comparison between the measured signal and the second signal, where the second signal corresponds to an intended output light of the analog display element. In some implementations, the computer-readable storage medium can further include applying a second driving condition to the analog display element, where the second driving condition is configured to place the analog display element in a reference state in which the analog display element outputs a reference color which remains substantially constant over the lifetime of the analog display element, and measuring a reference signal indicative of the color of light incident upon the at least one color sensor during application of the second driving condition to provide an indication of the effect of ambient lighting conditions on the signals measured by the color sensor.

Details of one or more implementations of the subject matter described in this disclosure are set forth in the accompanying drawings and the description below. Although the examples provided in this disclosure are primarily described in terms of EMS and MEMS-based displays, the concepts provided herein may apply to other types of displays such as liquid crystal displays (LCDs), organic light-emitting diode (OLED) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a flow diagram illustrating a manufacturing process for an IMOD display or display element.

FIGS. 4A-4E are cross-sectional illustrations of various stages in a process of making an IMOD display or display element.

FIGS. 5A and 5B are schematic exploded partial perspective views of a portion of an electromechanical systems (EMS) package including an array of EMS elements and a backplate.

FIG. 6 is a schematic cross-section showing an example of an analog IMOD.

FIG. 7 is an example of a chromaticity diagram including an analog color spiral illustrating a sequence of colors corresponding to the light reflected by an analog IMOD in various positions.

FIG. 8A is a top plan schematic view of an example of a display device including a frontlight system and color calibration sensors.

FIG. 8B is a schematic cross-section of the display device of FIG. 8A, taken along the line 8B-8B.

FIG. 8C is a schematic cross-section of the display device of FIG. 8A, taken along the line 8C-8C.

FIG. 9 is a schematic cross-section of a display device in which display elements are supported by a substrate including light-turning elements.

FIG. 10 is a schematic cross-section of a section of a display device in which color calibration sensors and display elements are located on the same side of a supporting substrate.

FIG. 11 is a flow diagram illustrating a method of measuring the color output by an analog display element.

FIGS. 12A and 12B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Analog or multistate display elements such as analog interferometric modulators (AIMODs) or multistate interferometric modulators (MS-IMODs) can be configured to output multiple colors, such as by reflection of particular colors or emission of particular colors using various display technologies. A measurement of an actual color output by a display element can be made, and can be fed back to a control system and compared with the expected color output in response to a particular input. The results of the comparison between the actual and expected color output may then be used as part of a calibration process to correct for discrepancies in color output, such as by adjusting driving voltages for an AIMOD. These color measurements may be made through the use of sensors incorporated within a display device, to provide color calibration over the lifetime of the display device without the need for calibration components external to the display device.

Particular implementations of the subject matter described in this disclosure can be implemented to realize one or more of the following potential advantages. In some implementations, display devices such as reflective display devices may include a frontlight film including light-turning features, and color sensors may be placed in optical communication with the frontlight film to provide a color measurement system with minimal additional components. By utilizing a frontlight film or similar light-turning structure, the color measurement components can be located outside of the viewing area of a display where it will not interfere with or block a portion of the display. In some implementations, a calibration system may only need to detect a shift in relative color coordinates in order to recalibrate a miscalibrated device, rather than absolute color coordinates. An integrated color calibration system can be used to increase the usable lifetime of a display device which includes display elements susceptible to shifts in color output as the display element ages, but also can be used for initial calibration and testing of display elements. Calibration measurements may be performed on an entire display, a portion of the display, a single row or column of display elements or even a single display element. With a sufficiently fast detector the color measurements may be performed during normal operation of the display without being perceptible to a user viewing the display. In addition, when the color sensor is integrated within the display, calibration can be performed without the need for external calibration components.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

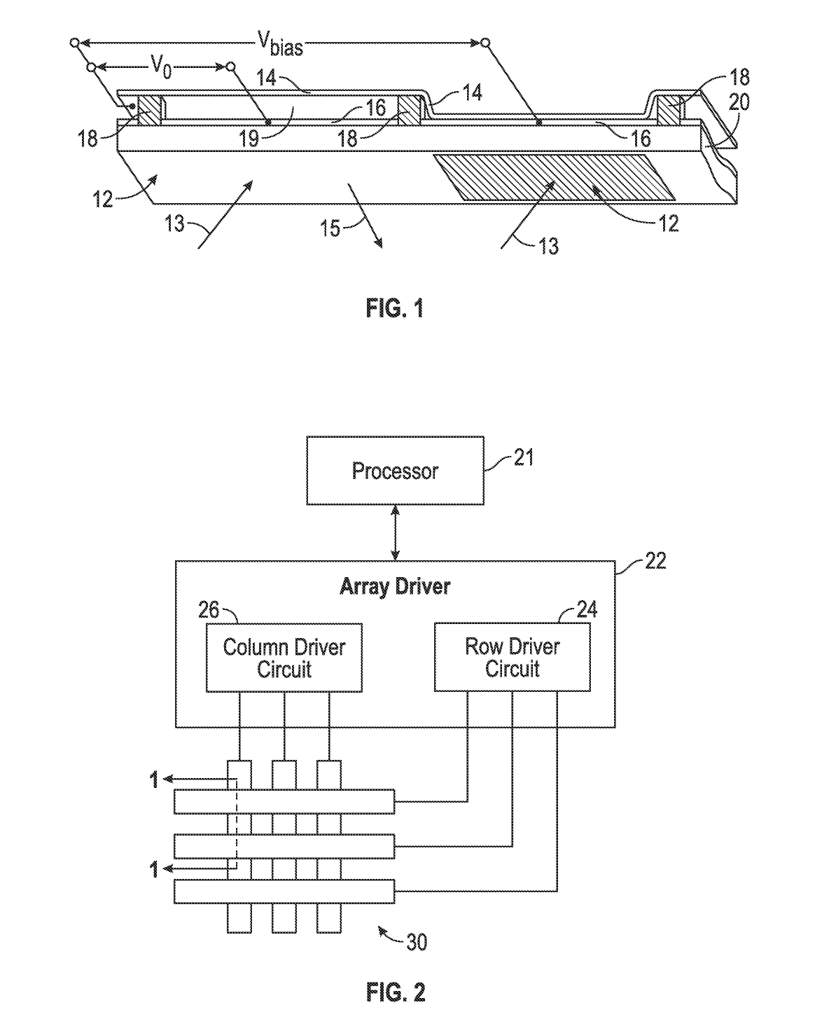

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (such as chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (such as of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

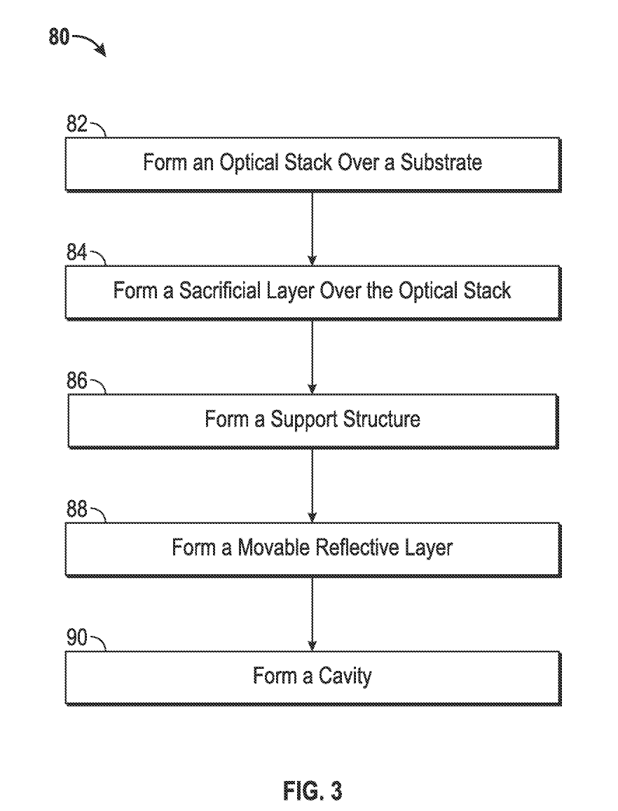

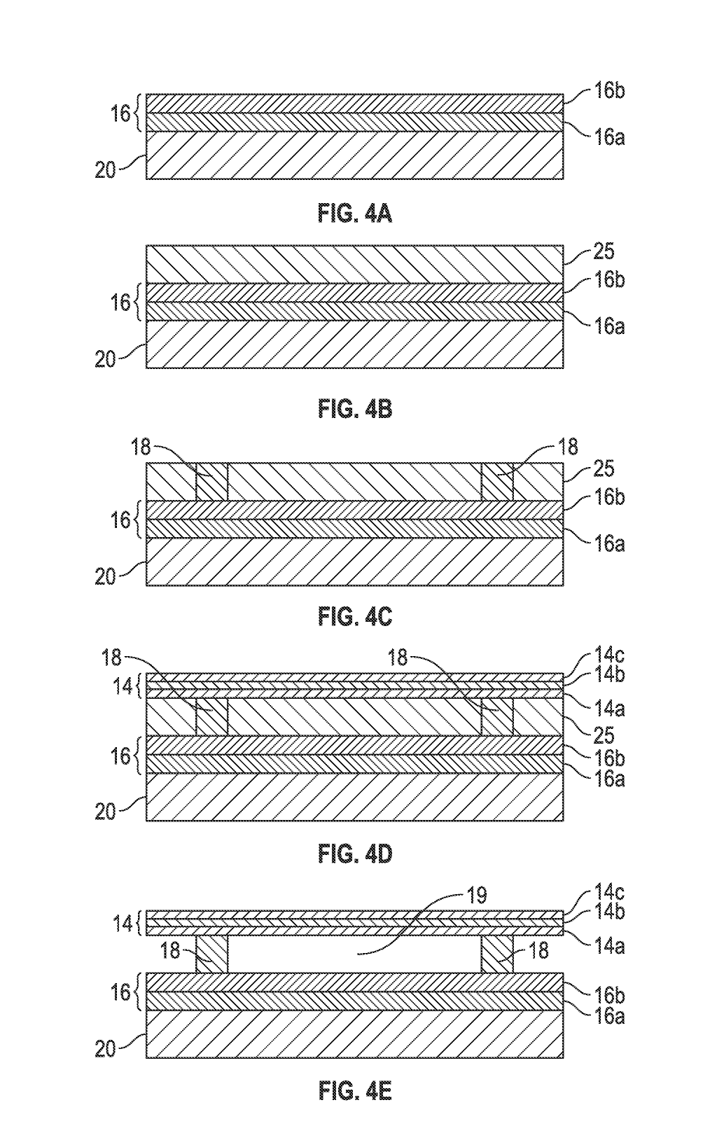

FIG. 3 is a flow diagram illustrating a manufacturing process 80 for an IMOD display or display element. FIGS. 4A-4E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 3. The process 80 begins at block 82 with the formation of the optical stack 16 over the substrate 20. FIG. 4A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 4A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (such as relative to other layers depicted in this disclosure), even though the sub-layers 16a and 16b are shown somewhat thick in FIGS. 4A-4E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 4B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 4E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 4C, the aperture formed in the sacrificial layer 25 can extend through the sacrificial layer 25, but not through the optical stack 16. For example, FIG. 4E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 4C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 4D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 4D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

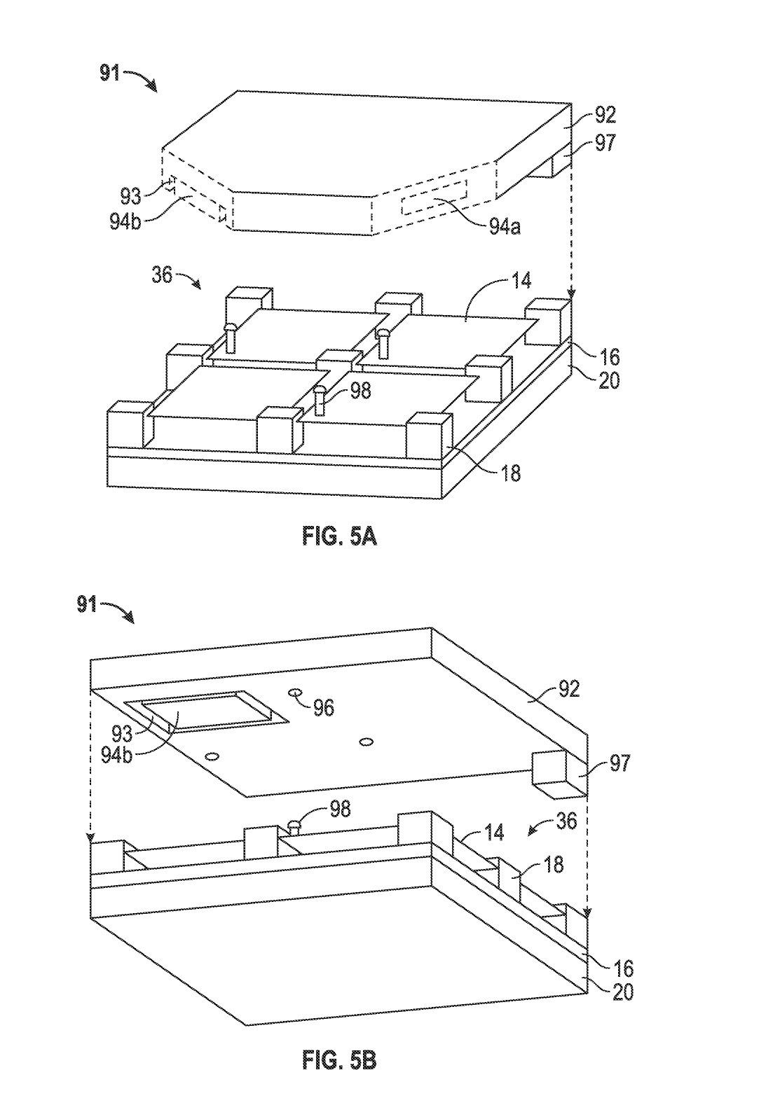

FIGS. 5A and 5B are schematic exploded partial perspective views of a portion of an EMS package 91 including an array 36 of EMS elements and a backplate 92. FIG. 5A is shown with two corners of the backplate 92 cut away to better illustrate certain portions of the backplate 92, while FIG. 5B is shown without the corners cut away. The EMS array 36 can include a substrate 20, support posts 18, and a movable layer 14. In some implementations, the EMS array 36 can include an array of IMOD display elements with one or more optical stack portions 16 on a transparent substrate, and the movable layer 14 can be implemented as a movable reflective layer.

The backplate 92 can be essentially planar or can have at least one contoured surface (for example the backplate 92 can be formed with recesses and/or protrusions). The backplate 92 may be made of any suitable material, whether transparent or opaque, conductive or insulating. Suitable materials for the backplate 92 include, but are not limited to, glass, plastic, ceramics, polymers, laminates, metals, metal foils, Kovar and plated Kovar.

As shown in FIGS. 5A and 5B, the backplate 92 can include one or more backplate components 94a and 94b, which can be partially or wholly embedded in the backplate 92. As can be seen in FIG. 5A, backplate component 94a is embedded in the backplate 92. As can be seen in FIGS. 5A and 5B, backplate component 94b is disposed within a recess 93 formed in a surface of the backplate 92. In some implementations, the backplate components 94a and/or 94b can protrude from a surface of the backplate 92. Although backplate component 94b is disposed on the side of the backplate 92 facing the substrate 20, in other implementations, the backplate components can be disposed on the opposite side of the backplate 92.

The backplate components 94a and/or 94b can include one or more active or passive electrical components, such as transistors, capacitors, inductors, resistors, diodes, switches, and/or integrated circuits (ICs) such as a packaged, standard or discrete IC. Other examples of backplate components that can be used in various implementations include antennas, batteries, and sensors such as electrical, touch, optical, or chemical sensors, or thin-film deposited devices.

In some implementations, the backplate components 94a and/or 94b can be in electrical communication with portions of the EMS array 36. Conductive structures such as traces, bumps, posts, or vias may be formed on one or both of the backplate 92 or the substrate 20 and may contact one another or other conductive components to form electrical connections between the EMS array 36 and the backplate components 94a and/or 94b. For example, FIG. 5B includes one or more conductive vias 96 on the backplate 92 which can be aligned with electrical contacts 98 extending upward from the movable layers 14 within the EMS array 36. In some implementations, the backplate 92 also can include one or more insulating layers that electrically insulate the backplate components 94a and/or 94b from other components of the EMS array 36. In some implementations in which the backplate 92 is formed from vapor-permeable materials, an interior surface of backplate 92 can be coated with a vapor barrier (not shown).

The backplate components 94a and 94b can include one or more desiccants which act to absorb any moisture that may enter the EMS package 91. In some implementations, a desiccant (or other moisture absorbing materials, such as a getter) may be provided separately from any other backplate components, for example as a sheet that is mounted to the backplate 92 (or in a recess formed therein) with adhesive. Alternatively, the desiccant may be integrated into the backplate 92. In some other implementations, the desiccant may be applied directly or indirectly over other backplate components, for example by spray-coating, screen printing, or any other suitable method.

In some implementations, the EMS array 36 and/or the backplate 92 can include mechanical standoffs 97 to maintain a distance between the backplate components and the display elements and thereby prevent mechanical interference between those components. In the implementation illustrated in FIGS. 5A and 5B, the mechanical standoffs 97 are formed as posts protruding from the backplate 92 in alignment with the support posts 18 of the EMS array 36. Alternatively or in addition, mechanical standoffs, such as rails or posts, can be provided along the edges of the EMS package 91.

Although not illustrated in FIGS. 5A and 5B, a seal can be provided which partially or completely encircles the EMS array 36. Together with the backplate 92 and the substrate 20, the seal can form a protective cavity enclosing the EMS array 36. The seal may be a semi-hermetic seal, such as a conventional epoxy-based adhesive. In some other implementations, the seal may be a hermetic seal, such as a thin film metal weld or a glass frit. In some other implementations, the seal may include polyisobutylene (PIB), polyurethane, liquid spin-on glass, solder, polymers, plastics, or other materials. In some implementations, a reinforced sealant can be used to form mechanical standoffs.

In alternate implementations, a seal ring may include an extension of either one or both of the backplate 92 or the substrate 20. For example, the seal ring may include a mechanical extension (not shown) of the backplate 92. In some implementations, the seal ring may include a separate member, such as an O-ring or other annular member.

In some implementations, the EMS array 36 and the backplate 92 are separately formed before being attached or coupled together. For example, the edge of the substrate 20 can be attached and sealed to the edge of the backplate 92 as discussed above. Alternatively, the EMS array 36 and the backplate 92 can be formed and joined together as the EMS package 91. In some other implementations, the EMS package 91 can be fabricated in any other suitable manner, such as by forming components of the backplate 92 over the EMS array 36 by deposition.

Although the IMODs of FIG. 1 are illustrated in only two positions, some implementations of IMODs can be driven in a multistate or analog manner to any of a wide range of discrete positions. In contrast to an IMOD driven in a bi-stable fashion, which generally reflects one color of light in a relaxed position and reflects a second color of light in an actuated position, an IMOD driven in a multistate or analog manner can reflect a particular color of light at each position within the range of discrete positions. In some implementations, an analog IMOD may be driven by control circuitry which is configured to drive the analog IMOD to any position within a stable range of travel, as well as one or more positions outside the stable range of travel, as discussed in greater detail below.

Although the term “analog” is used herein to describe display elements and methods of driving display elements, the term “analog” is not intended to exclude implementations in which a display element can be driven to one of a finite number of discrete positions or operating conditions, unless specifically noted otherwise. In such implementations, for example, an analog IMOD may be driven via control circuitry which is configured to apply a plurality of discrete driving conditions to the analog IMOD, where each of the plurality of driving conditions is associated with a position of the IMOD and a corresponding discrete color output of the IMOD. These discrete driving conditions may be associated with movable layer positions both within and outside of the stable travel range of the analog IMOD. By providing a limited number of possible driving conditions, the driving circuitry used to control the analog IMOD may be simplified. In some implementations, at least five discrete driving conditions may be provided, each associated with a particular color (including a white state and a black state) reflected by the IMOD in response to the driving condition; although in other implementations more or less than four discrete driving conditions may be provided.

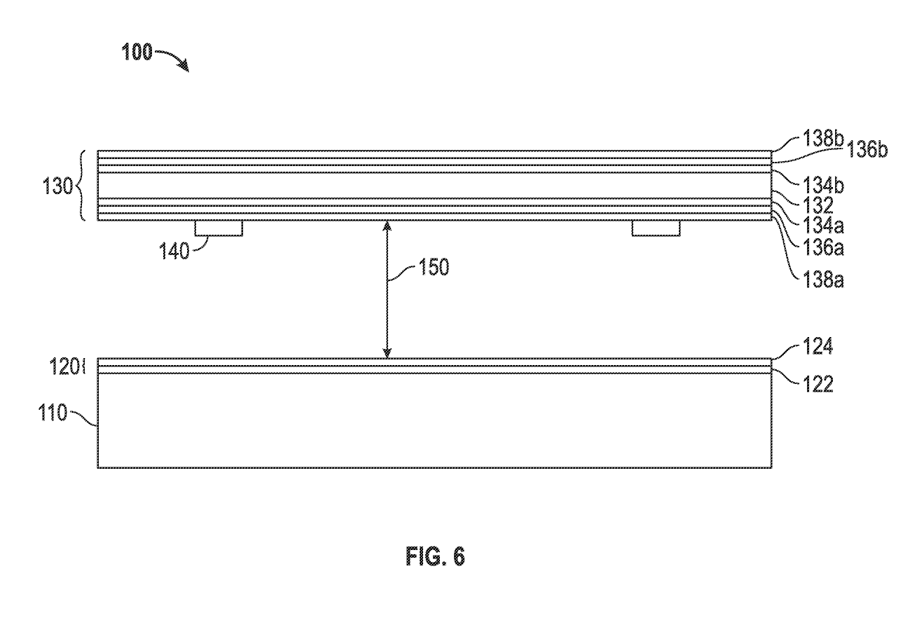

FIG. 6 is a schematic cross-section showing an example of an analog IMOD. The analog IMOD 100 includes an optical stack 120 supported by a substrate 110, and a movable layer 130 spaced apart from the optical stack 120 by a gap 150. Although described as a stack, the optical stack 120 may in some implementations include only a single layer. In the illustrated implementation, the optical stack 120 includes a conductive absorber 122 and a dielectric spacer layer 124. In one particular implementation, the conductive absorber 122 includes a layer of a molybdenum-chromium (MoCr) alloy roughly 50 Angstroms in thickness, and the dielectric spacer layer includes an optical oxide layer of aluminum oxide (Al₂O₃) roughly 100 Angstroms in thickness. In some other implementations, however, these and other layer may be thicker or thinner than the example thicknesses provided. For example, the MoCr layer may be between roughly 5 and 9 nm in thickness, and the Al₂O₃ layer may be between roughly 9 and 15 nm in thickness. Other thicknesses and/or materials also may be used.

The movable layer 130 may include a combination of layers which provide desired structural and optical properties. In the illustrated implementation, the movable layer 130 includes a support layer 132, which may include a dielectric material. In one particular implementation, the support layer 132 includes a layer of silicon oxy-nitride (SiON) roughly 1 μm in thickness. In some other implementations, the SiON layer may be in the range of 500-2000 nm, and an additional SiON layer of similar thickness also may be included to provide a symmetric movable layer 130. The movable layer 130 also includes a reflective layer 134a on the side of the movable layer 130 facing the optical stack 120. In a particular implementation, the reflective layer 134a includes a layer of an aluminum-copper (AlCu) alloy roughly 300 Angstroms in thickness. In other implementations, the AlCu layer may be thicker or thinner, and in some particular implementations may be between roughly 30 and 50 nm.

In order for the analog IMOD 100 to provide desired optical responses over the a range of possible positions of the movable layer 130, the movable layer 130 also can include one or more additional optical layers 136a and 138a on the side of the reflective layer 134a facing the optical stack 120. Although two additional optical layers 136a and 138a are illustrated, more or fewer optical layers may be included in other implementations. In a particular implementation, optical layer 136a includes a layer of SiON roughly 600 Angstroms in thickness, and optical layer 138a includes a layer of titanium oxide (TiO₂) roughly 350 Angstroms in thickness. As discussed above, other thicknesses and/or materials may be used. For example, in some implementations the TiO₂ (or other TiOₓ) may be between roughly 25 and 35 nm, and the SiON layer may be between roughly 57 and 81 nm.

Because mismatch of stresses within the layers of the movable layer 130 can induce bending of the movable layer 130, the movable layer 130 may be made symmetric or partially symmetric to prevent or minimize such stress mismatch. In the illustrated implementation, the movable layer 130 includes layers 134b, 136b and 138b, located on the opposite side of support layer 132 as layers 134a, 136a and 138a. To minimize stress mismatch within movable layer 130, layers 134b, 136b and 138b may be substantially the same composition and size as layers 134a, 136a and 138a, respectively.

In some implementations, the movable layer 130 may have a stable travel range over some percentage of the distance between maximum gap distance when the movable layer 130 in the fully relaxed or unactuated position and the optical stack 120. The stable travel range of the movable layer 130 may vary based on both the design of the analog IMOD 100 and the method in which the analog IMOD 100 is driven. At the edge of the stable travel range, the movable layer 130 may tilt against or collapse against the underlying optical stack 120. In some implementations, spacers 140 may be provided in order to provide a stable position close to the optical stack 120 in which the gap 150 is relatively small in comparison to the maximum gap size but greater than a minimum gap size.

Upon application of driving conditions to the analog IMOD 100 which move the movable layer 130 past the stable travel range of the analog IMOD 100, the movable layer 130 may move to a position in which the spacers 140 are in contact with the optical stack 122 or underlying layers, and the movable layer 130 is substantially parallel to the optical stack 120 and spaced apart from the optical stack 120 by a gap 150 roughly equal to the thickness of spacers 140. Application of other driving conditions, such as an increased voltage or charge between the movable layer 130 and the optical stack 120, will deform the movable layer 130 downward in the areas between spacers 130, decreasing the height of gap 150 to a minimum value.

The analog IMOD 100 of FIG. 6 may thus be driven to a range of positions within a stable travel range of the analog IMOD 100, as well as at least two discrete positions beyond the stable travel range of the analog IMOD 100. In a particular implementation in which the analog IMOD 100 includes layers of the particular materials and thicknesses discussed above, and has a relaxed gap size of roughly 340 nm when no voltage is applied, the analog IMOD 100 may reflect colors as follows. At the relaxed gap size of 340 nm, when the movable layer 130 is in a relaxed position, the effective size of the air gap may be slightly larger, due to the presence of additional optical layers within the optical stack and movable layer, and the analog IMOD 100 may reflect red light. As the movable layer 130 moves closer to the optical stack 120 in response to the application of voltage or charge, the color reflected by the IMOD will shift first to orange, followed by shifting to yellow, green and cyan in turn.

Depending on the stable travel range of the analog IMOD 100, which may in some implementations be roughly 60% of the total gap distance, the analog IMOD 100 may cycle through different colors before reaching a point at which the analog IMOD 100 tilts or collapses. If the spacers 140 are roughly 115 nm in thickness, the movable layer 130 will first reach a state in which the movable layer 130 is parallel to the optical stack 120 but spaced apart from the optical stack 120 by roughly the height of the spacers 140. The analog IMOD 110 may be substantially non-reflective to visible light in this position, also referred to as a black state. Finally, upon application of additional charge or voltage, the movable layer 130 may deform and collapse against the optical stack 120 in the areas between spacers 140, reaching a collapsed state in which the analog IMOD is reflective over a wide range of visible wavelengths, also referred to as a white state. The above implementation of an analog IMOD is merely an example, and through modification of the structure, dimensions, and materials of the various components of an analog IMOD, other analog IMODs having different optical properties can be formed. For example, by varying the gap size in a relaxed state, the color progression throughout the stable range can be modified to begin and/or end at different locations in the color cycle described above. A wide variety of other modifications may be made to provide analog IMODs which may have properties which differ from the analog IMOD 100 described above.

In some implementations, a second driving electrode (not shown) positioned on the opposite side of the movable layer 130 as the conductive absorber 122, and can electrostatically displace the movable layer 130 in the opposite direction and away from the conductive absorber 122. The inclusion of a second driving electrode can increase the stable travel range of the IMOD 100, and allow the IMOD 100 to reflect additional colors by providing one or more stable positions of the movable layer 130 where the gap size is larger than the relaxed gap size of the IMOD 100 which occurs when no voltage is applied. For example, when the gap size is further increased from the relaxed gap size to 450 nm, the color reflected by IMOD 100 will shift from red, to magenta, and then to blue light at 450 nm.

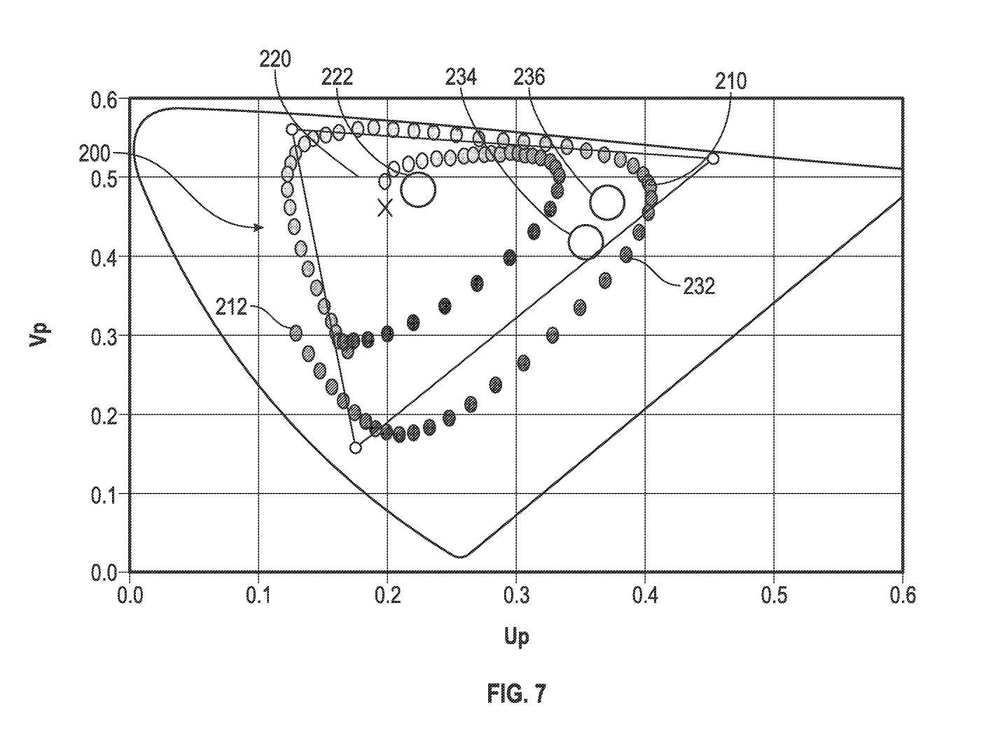

FIG. 7 is an example of a chromaticity diagram including an analog color spiral illustrating a sequence of colors corresponding to the light reflected by an analog IMOD in various positions. As the position of a movable reflective layer in analog IMOD 100 of FIG. 6 will affect the color reflected by the analog IMOD 100, color spiral 200 illustrates, in u-v chromaticity coordinates, the color reflected at a variety of movable reflective layer positions between the relaxed position at 210 and the fully collapsed position 220. As described above, the color of light reflected by the analog IMOD 100 in a fully relaxed position 210 is a red color, while the color of light reflected by the analog IMOD 100 in a fully collapsed position 220 (when the movable layer 130 between the spacers 140 is collapsed against the underlying optical stack 120) is very close to the white point of the chromaticity diagram shown by the X. In an implementation in which the IMOD 100 includes a second driving electrode as described above, the gap size can be further increased to a position 212 in which the IMOD 100 can reflect a blue light. The above description of the color spiral 200 is directed to a two-terminal analog IMOD, including a movable layer and a single fixed electrode, in which the relaxed position may correspond to the maximum gap height. In some other implementations, as discussed above, an analog IMOD may be a three-terminal device which includes a movable layer and two fixed electrodes, one on each side of the movable layer. In such an implementation, in which the movable layer can be electrostatically displaced in two directions, the relaxed position may correspond instead to a gap height which is between the maximum gap height and the minimum gap height.

A color spiral, such as color spiral 200, can be defined for an analog IMOD including layers of given dimensions and composition, and will define the range of possible colors which can be reflected by that analog IMOD. The order of the colors in the color spiral 200 itself will not change, as the color spiral 200 is dependent upon the structure of the analog IMOD, including for example the material and thickness of each of the layer or layers between a reflective layer (such as reflective layer 134a) and an absorber layer (such as the conductive absorber 122) in a particular analog IMOD. Information corresponding to a known analog color spiral 200 for a given analog IMOD can be stored, for example, in a control or testing system.

However, due to changes in the analog IMOD over time, the color reflected by the analog IMOD in response to a particular driving condition may change. For example, the movable layer may fatigue over time, and require the application of less charge or a lower voltage to induce a particular amount of movement in the movable layer. The stable travel range of the movable layer in the analog IMOD also may change due to weakening of the movable layer, and a color which was once within the stable travel range may no longer be within the stable travel range of the IMOD. The effect of these changes in the properties of the analog IMOD over time may be to shift the color output for a given driving condition along the color spiral 200. For example, a driving condition intended to cause the movable layer 130 of analog IMOD 100 to move to a position 210 where the analog IMOD 100 reflects a red color may instead cause the movable layer 130 of analog IMOD 100 to move to a position 232 where the analog IMOD 100 reflects a more magenta color. In the illustrated implementation, the driving condition which is intended to cause the movable layer 130 to move to a position 210 is the application of no voltage, but any other suitable driving condition may be used for calibration purposes. In some implementations, a driving condition may be selected in which the movable layer 130 is at least partially displaced.

Because change in the properties of an analog display element such as an analog IMOD may occur over the lifetime of a device, a sensor integrated within a device including analog display elements can detect these changes as they occur. In further implementations, the device can be configured to compensate for these changes to extend a useful lifetime of the device.

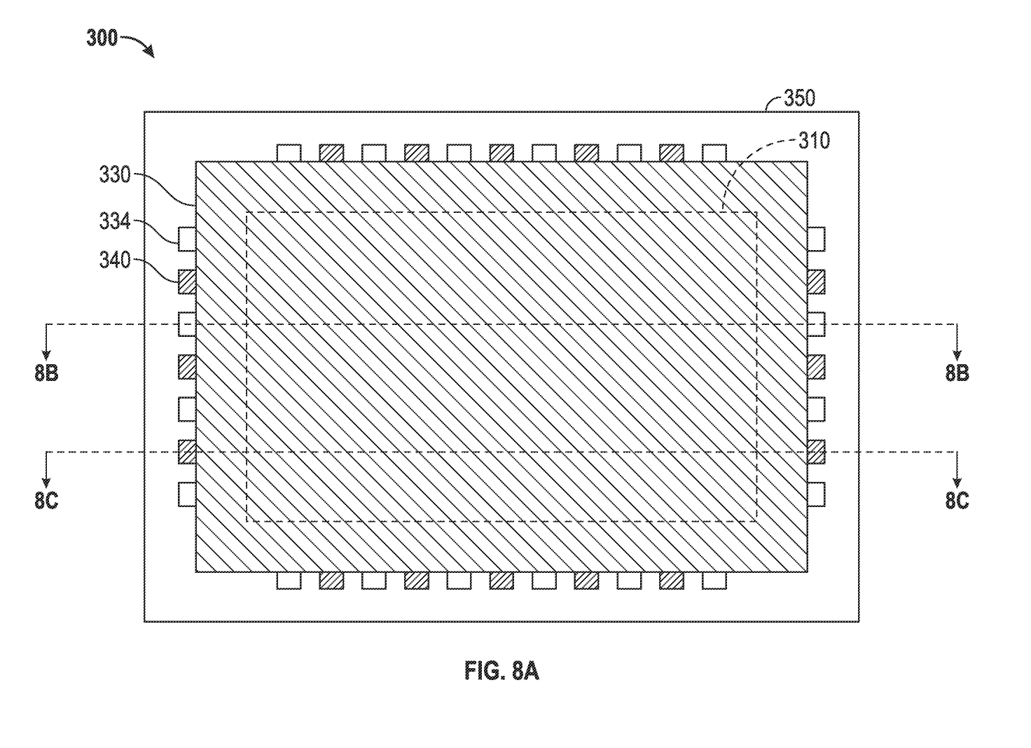

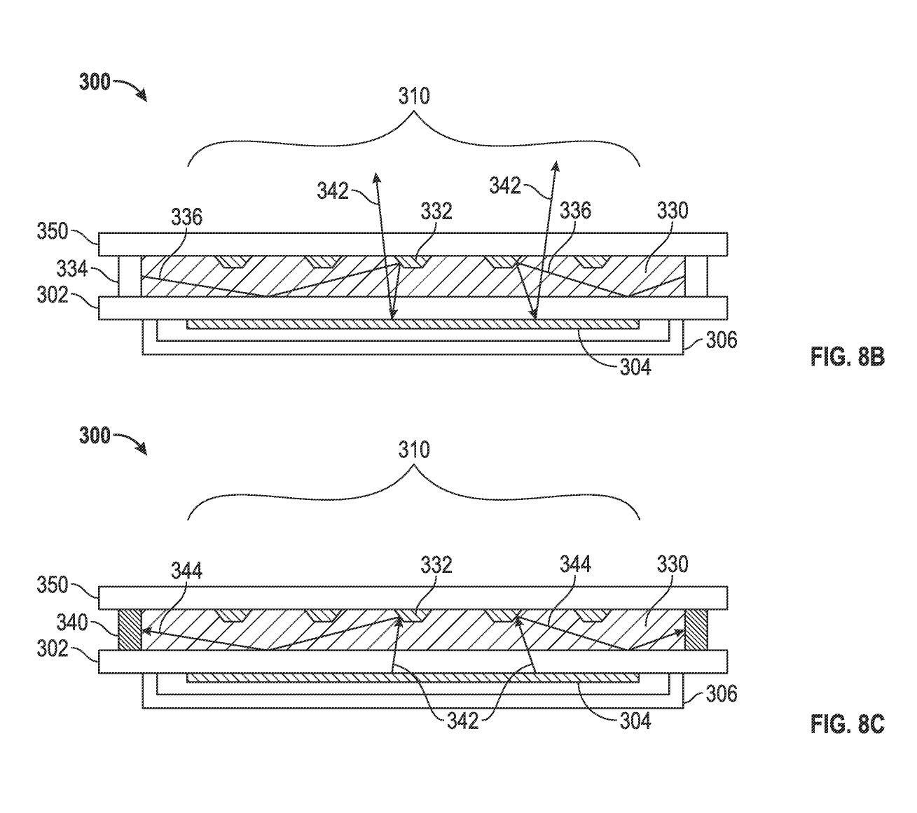

FIG. 8A is a top plan schematic view of an example of a display device including a frontlight system and color calibration sensors. The display device 300 includes a display region 310 corresponding to the dimensions of the active area of an underlying display 304 (see FIGS. 8B and 8C). A light-turning layer 330 which in the illustrated implementation extends beyond the edges of display region 310 and cooperates with light sources 334 such as light-emitting diodes (LEDs) in optical communication with the light-turning layer 330 to form a frontlight system. Although referred to herein as LEDs, a wide variety of other light sources can be used in place of light sources 334. In some implementations, the calibration light sources 334 may be the same light sources used by the frontlight system to illuminate the underlying display, and may be configured to emit broadband white light, but in other implementations, the calibration light sources 334 may be configured to emit light of specific wavelengths, such as a narrow band of wavelengths around a color configured to be used as a calibration color. Similarly, although referred to herein as a light-turning layer 330, the light-turning layer 330 may alternately be referred to as a light-turning film or a light-turning plate, and may be of any appropriate thickness, material, or flexibility in various implementations.

At least one color sensor 340 is also in optical communication with the light-turning layer 330. In the illustrated implementation, multiple color sensors 340 and light sources 334 are disposed along each edge of the light-turning layer 330, but in some other implementations, only a single color sensor 340 may be used, and light sources 334 may not be disposed adjacent all edges of the light-turning layer 330. A cover glass 350 overlies the light-turning layer 330, and in the illustrated implementation extends beyond the edges of the light-guiding layer 330 to cover the light sources 334 and color sensors 340. In some implementations, the cover glass 350 may not be a rigid layer, but may be a film applied over the surface of the light-turning layer 330. Additional layers (not shown), also may be included. For example, in some implementations, a diffuser layer may be located between the reflective display 304 and the light-turning layer 330.

The color sensors 340 may in some implementations be colorimeters, or a group of three photodiodes with red, green, and blue filters, respectively, and provide a means for sensing a color of light propagating within the light-turning layer 330. Because the color of the light that will be measured by the display element will be affected by ambient lighting conditions, as discussed in greater detail below, the color sensors 340 need not be precisely calibrated, and may in some implementations only measure a relative shift in color or signals indicative of color shift, rather than precise actual color coordinates of the light incident upon the color sensors 340. This may allow the use of simpler and/or lower-cost color sensors. In some other implementations, more or different color sensors may be used. For example, color sensors sensitive to colors other than red, green, and blue may be used in addition to or in place of one or more of the red, green, and blue sensors discussed above.

In some particular implementations, sensors which are sensitive to light outside of the visible wavelengths may be used. As the air gap of an analog IMOD moves from larger to smaller, the peak wavelength reflected by the analog IMOD may move from red, through green, to blue, as discussed above. If the air gap is made even smaller, the peak reflected wavelength may move into the ultraviolet (UV) range, and if the air gap is made sufficiently large, the peak reflected wavelength may move into the infrared (IR) range. However, the range of possible UV and IR wavelengths which can be reflected by a given analog IMOD are also defined by the structure of the analog IMOD, and can be used to calibrate the analog IMOD in the same manner as a visible reflected color of light.

If some or all of the color sensors are sensitive to one or both of UV or IR radiation, a peak reflected wavelength in either the UV or IR range can be used to calibrate the analog IMOD. By utilizing wavelengths outside of the visible range for calibration of the analog IMOD, a UV or IR calibration light source can be used which is not visible to a user. In such an implementation, calibration light sources different from the frontlight light sources configured to emit visible light also may be included, and may be configured to emit light only in the UV or IR range. The display also may include one or more UV or IR shielding layers that prevent interference from external UV or IR light without affecting the appearance of the display in the visible range of wavelengths.

FIG. 8B is a schematic cross-section of the display device of FIG. 8A, taken along the line 8B-8B. The display 300 includes a panel substrate 302 underlying the light-turning layer 330 and supporting a display 304 including an array of analog display elements. In one implementation, the display 304 is a reflective display, such as an array of analog IMODs. A backplate 306 is sealed to the panel substrate 302 to protect the display 306.

It can be seen in FIG. 8B that the light-turning layer 330 includes light-turning features 334 formed in or extending into the upper surface of the light-turning layer 330. The light-turning features 332 are located on the opposite side of the light-turning layer 330 as the display 302. In some implementations, the light-turning features 332 include a layer of reflective material, while in some other implementations, light-turning features may include angled surfaces formed in the upper surface of the light-turning layer 330. Although schematically depicted as large relative to the other components of display 300, the light-turning features 332 may be smaller and more numerous in actual implementations. The smaller size may prevent them from being easily perceived by a viewer, and the greater number of light-turning structures 332 may help to provide substantially even illumination across the display area 310. In some implementations, the light-turning features 332 may simply include angled surfaces and rely on total internal reflection to turn light, while in other implementations, the light-turning features 332 may include a layer of reflective material.

As noted above, the light sources 334 may cooperate with the light-turning layer 330 to form a frontlight system. Light 336 emitted from the light sources 334 at the periphery of the light-turning layer 330 propagates within the light-turning layer 330 by means of total internal reflection due to the light-turning layer 330 including a material which has a higher index of refraction than the adjacent layers. When light 336 strikes light-turning features 332, the light 336 is reflected downward and out of the light-turning layer 330 and towards display 304. In an implementation in which the display 304 includes an array of analog IMODs, light incident upon a given analog IMOD may reflect light of a particular color based on the spacing between a reflective layer and an absorber layer within the analog IMOD as discussed above. The light 342 reflected by the display 304 then passes through the light-turning layer 330 and towards, for example, a viewer.

In addition to turning light 336 injected from the edge of the light-turning layer 330 towards the display 304, the light-turning layer 330 also serves to redirect a portion of the light 342 reflected by display 304 back towards the edge of the light-turning layer 330 where it can be measured by color sensors 340. FIG. 8C is a schematic cross-section of the display device of FIG. 8A, taken along the line 8C-8C. It can be seen in FIG. 8C that a portion of the light 342 reflected off of the display 304 will strike a light-turning feature 332 and be turned into the light-turning layer 330. This reflected light 344 can propagate within the light-turning layer 330 by total internal reflection, until a portion of the reflected light 344 reaches a color sensor 340 in optical communication with the light-turning layer 330. The color sensor 340 can output a signal indicative of the color of the light, including light 344 incident upon the color sensor 340, and may be in communication with measurement and/or calibration circuitry (not shown).

Because additional light not reflected from an analog display element within display 304 will also reach color sensor 340, the color of light incident upon and measures by the color sensor 340 may be only partially dependent upon the color of light reflected by an analog display element, and also may be partially dependent upon other factors such as the ambient lighting conditions and the reflectivity of other portions of the display 300. For example, in implementations in which the display 304 includes an array of analog IMODs, the light 342 will also be reflected off fixed portions of the display 304 between IMOD elements, and the composition of the incident light 336 itself also can affect the composition of the color of light received by the color sensor 340.

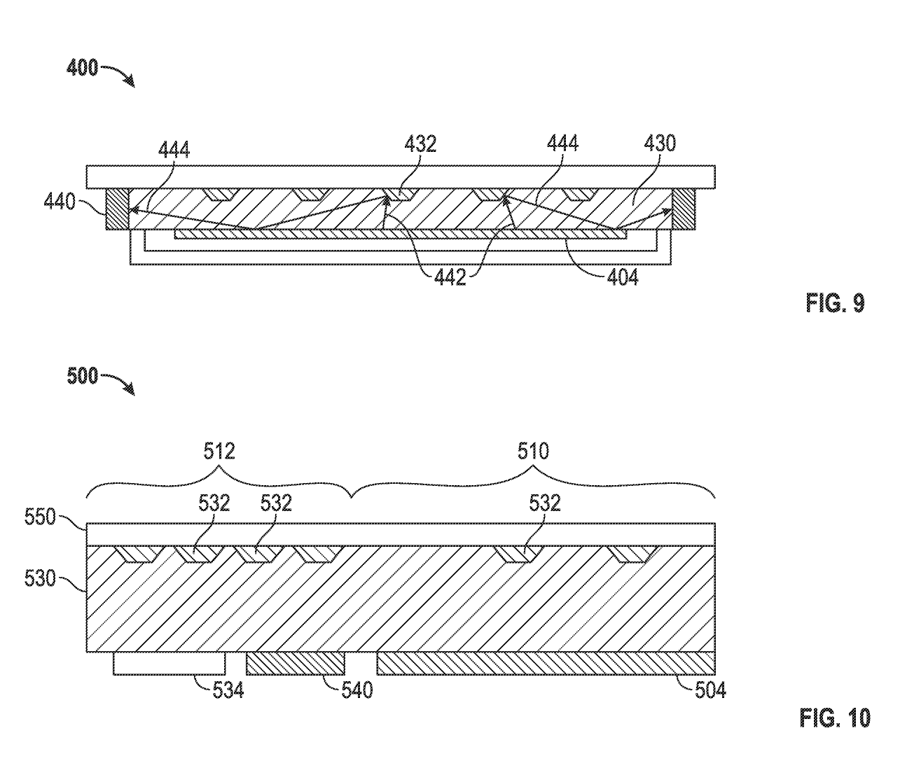

In the implementation of FIGS. 8A-8C, the reflective display 304 is supported by a substrate 302 which is distinct from the light-turning layer 330. However, in some other implementations, the reflective display may be supported by a substrate which also functions as a light-turning layer. FIG. 9 is a schematic cross-section of a display device in which display elements are supported by a substrate including light-turning elements. The display device 400 is similar to the display device 300 of FIGS. 8A-8C, except that the reflective display 404 of display device 400 is supported by a substrate 430 that serves as a light-turning layer and includes light turning features 432. Light 442 reflected by the reflective display 404 can be turned by the light turning features 432 and reflected as light 434 which propagates by total internal reflection through substrate 430 and to color sensors 440 at the periphery of the substrate 430. In some implementations, an intervening layer (not shown) such as a diffuser or a low-index cladding layer may be formed on substrate 430 prior to formation of the reflective display 404 thereon.

In some implementations, one or both of the light sources and color sensors may be located on the same side of a supporting substrate as the display elements. FIG. 10 is a schematic cross-section of a section of a display device in which color calibration sensors and display elements are located on the same side of a supporting substrate. In particular, FIG. 10 is a detailed view of an edge of a display system 500 which includes a peripheral section 512 outside of the display section 510. A substrate 530 includes light-turning features 532 formed on or adjacent a first side of the substrate, and supports a reflective display 504 located on the other side of the substrate 530 from the light-turning features 532. Although the light-turning features 532 are depicted as extending into the substrate 530, the light-turning features 532 can in other implementations be located within a separate film or layer on or adjacent the first side of the substrate 530. The reflective display 504 may include a plurality of analog display elements such as analog IMODs as discussed above. In the illustrated implementation, a light source 534 and a color sensor 540 are located on the same side of the substrate 530 as the reflective display 504, but are located in the peripheral region 512 of the display device 500. In some implementations, the light source 534 and the color sensor 540 may be located on the same side of the substrate 530 as the reflective display 504 but adjacent different portions of the reflective display 504, such as on opposite sides of the reflective display 504.

In some implementations, the light source 534 and the color sensor 540 may be discrete components which are adhered to or otherwise positioned adjacent the substrate 530, but in other implementations, one or both of the light source 534 and the color sensor 540 may be formed on the substrate 530 at the same time that a reflective display 504 is formed. In some implementations, the light source 534 may not be an LED, but may instead be an electroluminescent film or material or other light-emitting thin film structure that is formed on the surface of the substrate 530. Similarly, the color sensor 540 may be a thin film structure formed on the surface of the substrate 530, such as a structure including an amorphous silicon layer that is responsive to incident light.

In the illustrated implementation, the density of the light-turning features 532 in the peripheral region 512 may be greater than the density of the light-turning features 532 in the display region 510, as the light-turning features 532 in the peripheral region 510 can be shielded by an overlying bezel or similar structure (not shown) so as to not affect the appearance of the display device 500. Although the light-turning features 532 overlying the light source 534 and the color sensor 540 are illustrated as similar in shape to the light-turning features 532 overlying the reflective display 504, the light-turning features 532 may in other implementations be wedge-shaped instead of frustroconical or otherwise shaped to turn light in a specific direction.

By disposing the light source 534 and the color sensor 540 on the same side of the display, the light source 534 and the color sensor 540 may in some implementations be fabricated at the same time as the reflective display 504. This may reduce the cost of the fabricating the device 500 by reducing the number of discrete components which are added to the device 500. Even in implementations in which discrete, non-TFT structures are used as the light source 534 and/or the color sensor 540, the overall footprint of the display device 500 may be reduced by disposing these components underneath substrate 530 rather than at the edge of substrate 530 as shown in previous implementations. In some implementations, the light source 534 and the color sensor 540 may not be positioned in a line within the page as shown, but may instead be positioned along a line extending into the page, so that the size of the peripheral region 512 may be further reduced.

In some implementations, the color sensor 534 may be formed not within the peripheral region 512 of the display 500, but between display elements within the display region 510 of the display 500. As noted above, a TFT structure including a photosensitive material such as amorphous silicon can be used as a color sensor 534, and may be made sensitive to a particular color by include a layer of material adjacent the photosensitive material to serve as a color filter. By forming color sensors 534 throughout the display, greater detail regarding the output of particular display elements within reflective display 504 can be obtained, facilitating calibration of individual components or regions within reflective display 504.

In some other implementations, a color sensor may be formed in place of one or more individual display elements within a display. If color sensors replace display elements distributed throughout the display, accurate color sensing can be provided without significantly impacting the image produced by the display. For example, in some implementations, every 40×40 section of display elements can include a color sensor (or group of color sensors) replacing a display element, although other implementations may include greater or lesser densities of color sensors.

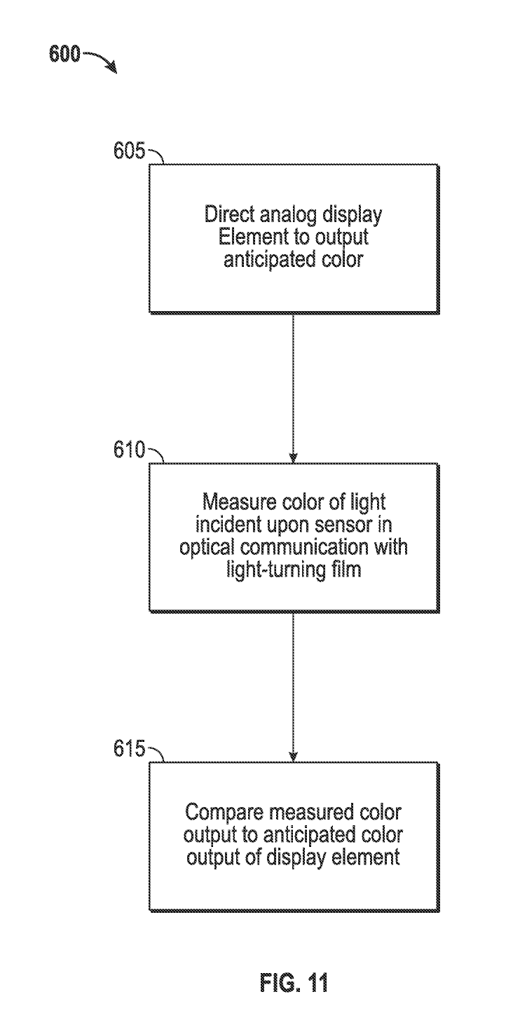

FIG. 11 is a flow diagram illustrating a method of measuring the color output by an analog display element. The method 600 includes a block 605 where an analog display element is directed to output an intended color. This direction may be achieved by applying particular driving conditions to the analog display element. For example, as discussed above, these driving conditions may relate to the application of a specific amount of charge or voltage to an analog IMOD. The driving conditions may be applied by driving circuitry in electrical communication with the analog display element.

The method 600 also includes a block 610 where the color of light incident upon at least one sensor in optical communication with a light-turning film, layer, or plate overlying the display element is measured. The color of light incident upon the sensor will be indicative of, but not necessarily identical to, the color of light output by the analog display element. Due to ambient lighting conditions and other factors, the actual measured color may be a color which is offset from the actual color output of the analog display element. In some implementations, the effect of ambient conditions can be minimized or compensated for by illuminating an analog display element such as an analog IMOD with light of a known color, such as through the use of white light in a frontlight system. Although the specification refers to measuring color, in some implementations only signals indicative of color are measured, recoded, analyzed, and/or compared to one another, and the actual colors or color coordinates themselves need not be explicitly calculated. The measurement and subsequent analysis may be performed by measurement and/or calibration circuitry in electrical communication with the color sensor. In some implementations, at least some of the measurement and/or calibration circuitry may be discrete circuitry, while other portions of the measurement and/or calibration circuitry may be integrated into, for example, another processor within a display device. In some implementations, the recalibration circuitry is in electrical communication with the driving circuitry so that the driving conditions associated with particular colors can be adjusted to reflect changes in the analog display element which alter the color output for a particular driving condition, as discussed in greater detail below.

The method 600 also includes a block 615 where the measured color is compared to the anticipated color output of the analog display element. As noted above, the measured color will not necessarily be identical to the anticipated color output of the analog display element even when the actual color output of the display element is identical to the anticipated color output. Nevertheless, the comparison may provide an indication of the degree of any variance between the anticipated color output of the analog display element. As noted above, this comparison need not require the calculation of color coordinates of the incident light or similar identifying details, but may instead only involve the measurement and comparison of signals indicative of the anticipated and incident colors. In some implementations, this comparison also may include additional steps such as the measurement of a reference value to account for the effect of ambient conditions, as discussed in greater detail below.

Referring again to FIG. 7, some positions of an analog IMOD 100 are less susceptible to shifts in the color of output light over time. For example, the fully collapsed position is generally a function of layer composition and thickness, which remain substantially constant over a period of time. When the analog IMOD 100 is driven to a known and controlled reference state such as a fully collapsed position, the color output in that position can be expected to remain constant over time, and therefore can be used to provide an indication of the influence of ambient light and other factors on the light received by a color sensor. In particular, the analog IMOD 100 is designed to reflect substantially white light in the fully collapsed position. However, the actual measured color may be a value 222 which is offset from the actual color output 220 of the analog IMOD in a fully collapsed state. Because the offset is from a known color, however, the use of a reference state can be used to provide an indication of the effect of the portion of light which is incident on the sensor 340 but not reflected from the analog IMODs in the reference state.

Information regarding the light from other sources incident on the sensor 340 can be used when the driving condition is changed to a second state expected to correspond to a second position 210 on the analog color spiral, such as the red state discussed above, which is susceptible to changes in color output. In this second state, the analog IMOD is expected to reflect the color 210 of light, but as discussed above, may in fact reflect a color 232 offset along the color spiral 200 from the expected color 220. As above, the color 234 measured by the color sensor 340 when the analog IMOD 100 is in the second state may be affected by ambient conditions and other factors and be offset from the color spiral 200 as shown in FIG. 7. However, the information regarding the ambient light or other sources can be used to provide a better indication of the actual color 232 output from the analog IMOD 100 when in the second state.

The measured color 234 may be compared with the expected color 210 to provide an indication of how the output of the analog IMOD 100 has changed from the expected output. As discussed above, in various implementations, this comparison may include the use of a constant or substantially constant output reference state to compensate for the effect of ambient lighting conditions, including other reflected light, or may include the illumination of the analog IMOD 100 with a frontlight system to minimize the effect of ambient conditions on the measured color 234.

Once an indication of the shift in color output has been measured, this information may be used in a recalibration process by altering the driving condition associated with the intended color output. In such a process, a driving or control system can be adjusted to reflect the change in the properties of the analog IMOD 100. If the effect of the change in, for example, the properties of the movable layer on the output of the IMOD can be characterized, the driving conditions can be adjusted to ensure that the intended output light is produced, improving the quality and extending the lifetime of a display incorporating such an analog IMOD 100. For example, the amount of charge or voltage applied to the analog IMOD 100 may be altered to reflect an updated amount of charge or voltage now required to move the movable reflective layer of the analog IMOD 100 to a desired position relative to the absorber. After recalibration of the driving conditions associated with color 210, the updated driving conditions may be applied to the analog IMOD 100, and a color 236 may be measured by the sensor 340, which indicates that the analog IMOD 100 is outputting a color which is closer or equal to the intended color output 210. In some implementations, the updated driving conditions may be applied in an “analog” manner by providing calibration data to a control system, such as a display driver, and altering the “analog” output value (which may at some point in the process be digitized) of the control system, such as the voltage or charge output by the control system to display an intended color. In some other implementations, the updated driving conditions may be applied in a “digital” manner, by translating an analog color correction to a digital color correction, and applying the digital color correction to incoming digital information by a display controller or image processing unit to change the image data such that it will be displayed in a desired manner taking into account the change in the response of the display elements to a particular control signal.

In some implementations, the measurement and possible recalibration can be done in a display-wide manner. In such an implementation, all of the analog display elements or a subset of the analog display elements distributed throughout the display may simultaneously be driven to a test state, and the color reflected by the display elements measured and compared to an expected value. Such processes may be used to identify the presence of and correct for changes which affect the display as a whole, whether permanent changes to the display elements or temporary changes due to changes in the operating conditions of the display (such as operation at extreme temperatures). If only a subset of the analog display elements are driven to a test state, the remaining analog display elements may be placed in a reference state, such as a dark state, to minimize interference with the testing process.

In some other implementations, more precise measurement and recalibration processes may be performed. In some implementations, particular regions of the display or individual display elements may be tested by selectively driving specific portions of the display. In some particular implementations, only a portion of the display elements within the array are driven to a test state and the other display elements in the array are driven to a dark state to isolate the output of the driven display elements.

In some other implementations, particular regions of the display can be tested by utilizing multiple sensors to measure color at various locations around the display, and any variance in the measured colors used to identify specific regions of the display in which the color output varies more than in other areas. In such implementations, each color sensor has a known location sensitivity such that, for example, less light is received from areas further away and more light is received for closer areas. By combining the measured signals from multiple color sensors, the location of each color component can be determined more accurately. In some implementations, the use of multiple sensors can be combined with the selective driving of specific portions of the display.

Although the illustrated system includes a frontlight system, other implementations need not include a frontlight system or any illumination system. In some implementations, an emissive or backlit display can be used in conjunction with a dedicated light-turning film, layer, or plate to redirect the display output towards one or more color sensors. In some other implementations, a reflective display can be driven and the output measured using only ambient lighting. In some implementations, a frontlight system may be used to illuminate a reflective display in some conditions, while in other conditions, ambient light alone may be used to illuminate the display and the light sources in the frontlight system may be turned off. In some particular implementations, the ambient conditions may be measured prior to the output testing and/or recalibration process to ensure that the ambient lighting conditions are appropriate. For example, if the ambient light is insufficient or is primarily of a single color, the light measured by a color sensor may not be sufficiently indicative of the output of an analog IMOD or similar display element, and supplemental illumination may be provided, or the measurement and/or calibration process may be delayed.

In addition, although some implementations discussed herein are primarily described with respect to the measurement and recalibration of analog IMODs, measurement and recalibration methods may be used in conjunction with any appropriate display element configured to output multiple discrete colors of light in response to different driving conditions, or for which the color output may vary over time due to degradation, failure or other changes in the display element. As noted above, in some implementations, an analog display element may be configured to output one of a plurality of colors in response to one of a plurality of driving conditions. In some implementations, an analog display element may be configured to output at least four different colors in response to at least four different driving conditions. Similarly, color sensors and associated measurement and control circuitry may be integrated into display devices incorporating such analog display elements.

In some implementations, the color calibration methods described herein can be used in conjunction with other calibration methods. For example, capacitance measurements also can be used to calibrate an analog IMOD display, as the capacitance of an IMOD element is a function of the distance between a movable electrode and a fixed electrode. In some implementations, capacitance measurements may be used between uses of the color calibration methods described above to provide a calibration monitoring system which does not depend on light for measurement and can be made invisible to the user more easily. For example, color calibration could be used when a device is turned on as part of the device startup process, and capacitance measurements could be used to monitor the calibration of the device while the device remains on.

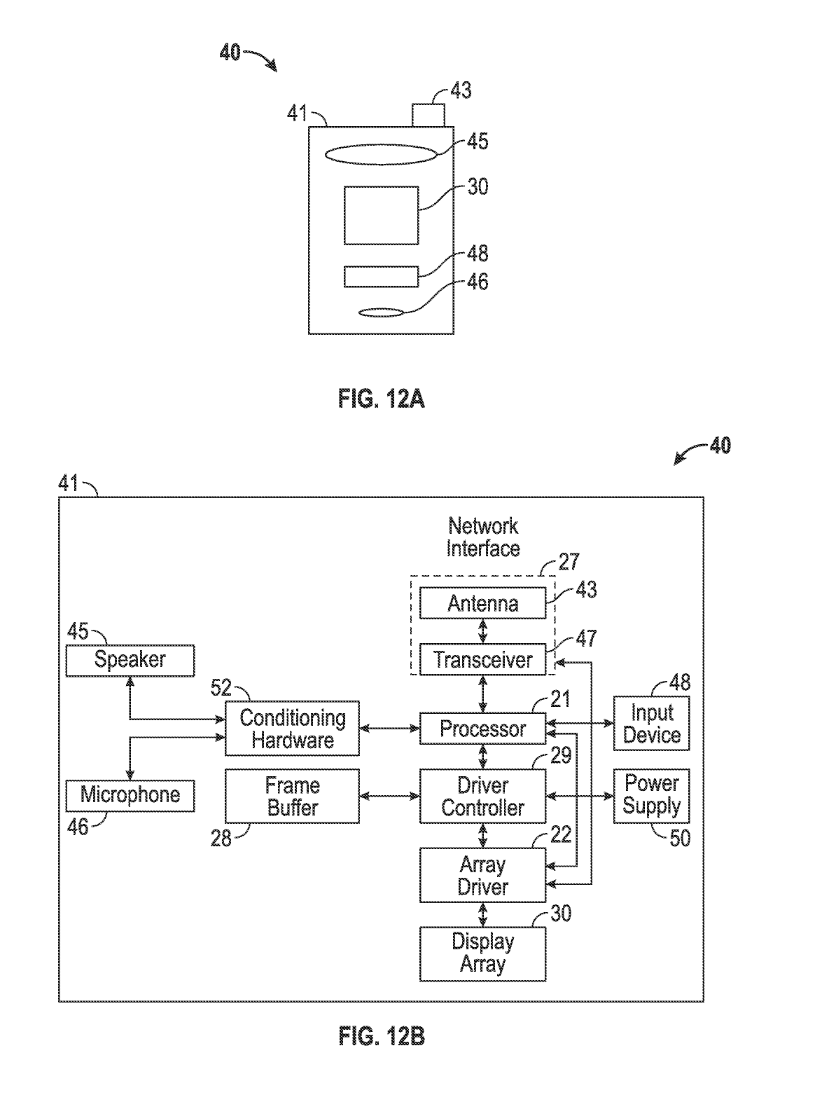

FIGS. 12A and 12B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 12A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable, analog or multistate display controller (such as an IMOD display element controller). Additionally, the array driver 22 can be a conventional driver or a bi-stable, analog or multistate display driver (such as an IMOD display element driver). Moreover, the display array 30 can be a conventional display array or a bi-stable, analog or multistate display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, flash memory, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, for example, an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A device, including:
a display including at least one analog display element, wherein the analog display element is configured to output light of one of a plurality of discrete colors in response to the application of one of a plurality of driving conditions;
a light-turning layer overlying the display, wherein the light-turning layer is configured to redirect a portion of output light reflected or emitted by the display into the light-turning layer; and
a color sensor in optical communication with the light-turning layer.

2. The device of claim 1, further including driver circuitry configured to apply at least a first driving condition to the analog display element, wherein the first driving condition is intended to cause the at least one display element to output a first color.

3. The device of claim 2, further including measurement circuitry configured to:
analyze at least a signal measured from the color sensor during application of the first driving condition to the at least one display element to provide an indication of the actual color output by the at least one display element; and
adjust the first driving condition if the actual color output by the at least one display element is different from the first color.

4. The device of claim 3, wherein:
the driver circuitry is further configured to apply a second driving condition to the analog display element, wherein the second driving condition is intended to cause the at least one display element to output a reference color, and wherein the reference color remains substantially constant over the lifetime of the analog display element; and
the measurement circuitry is configured to analyze a second signal measured from the color sensor during application of the second driving condition to the at least one display element to provide an indication of the effect of ambient lighting conditions on the signals measured by the color sensor.

5. The device of claim 1, wherein the analog display element includes an analog interferometric modulator (AIMOD), the AIMOD including a reflective layer spaced apart from an absorber layer by a distance which can be varied through application of the plurality of discrete driving conditions, and wherein a color of light reflected by the AIMOD is dependent upon the distance between the reflective layer and the absorber layer.

6. The device of claim 1, wherein the analog display element is a reflective display element.

7. The device of claim 4, further including a light source in optical communication with the light-turning layer, the light source cooperating with the light-turning layer to form a frontlight system.

8. The device of claim 1, wherein the color sensor includes at least one colorimeter in optical communication with the light-turning layer.

9. The device of claim 1, wherein the color sensor includes at least one group of photodiodes in optical communication with the light-turning layer, wherein the group of photodiodes includes:
a first photodiode, wherein light incident upon the first photodiode passes through a red filter;
a second photodiode, wherein light incident upon the second photodiode passes through a green filter; and
a third photodiode, wherein light incident upon the third photodiode passes through a blue filter.

10. The device of claim 1, wherein the color sensor includes thin film circuitry formed on the same side of a supporting substrate as the at least one analog display element.

11. The device of claim 1, further including:
a processor that is configured to communicate with the display, the processor being configured to process image data; and
a memory device that is configured to communicate with the processor.

12. The device of claim 11, further including:
a driver circuit configured to send at least one signal to the display; and
a controller configured to send at least a portion of the image data to the driver circuit.

13. The device of claim 11, further including at least one of:
an image source module configured to send the image data to the processor, wherein the image source module includes at least one of a receiver, transceiver, and transmitter; and
an input device configured to receive input data and to communicate the input data to the processor.

14. A method of sensing an output of a display device, comprising:
applying a first driving condition to an analog display element, wherein the analog display element is intended to output light of a first color in response to application of the first driving condition, and wherein at least a portion of the output light passes through a light-turning layer configured to turn at least a portion of the output light passing therethrough into the light-turning layer;
measuring a signal indicative of the color of light incident upon at least one color sensor, wherein the at least one color sensor is in optical communication with the light-turning layer; and
comparing the measured signal to a second signal to provide an indication of whether an actual color output by the at least one display element in response to the first driving condition is different from the first color.

15. The method of claim 14, further including illuminating the at least one analog display element during application of the first driving condition and measurement of the signal.

16. The method of claim 14, further including recalibrating the first driving condition based on the comparison between the measured signal and the second signal, wherein the second signal corresponds to an intended output light of the analog display element.

17. The method of claim 14, further including:
applying a second driving condition to the analog display element, wherein the second driving condition is configured to place the analog display element in a reference state in which the analog display element outputs a reference color which remains substantially constant over the lifetime of the analog display element; and
measuring a reference signal indicative of the color of light incident upon the at least one color sensor during application of the second driving condition to provide an indication of the effect of ambient lighting conditions on the signals measured by the color sensor.

18. A non-transitory, computer-readable storage medium having instructions stored thereon that cause a processing circuit to perform a method comprising:
applying a first driving condition to an analog display element of a display device, wherein the analog display element is intended to output light of a first color in response to application of the first driving condition, and wherein at least a portion of the output light passes through a light-turning layer of the display device configured to turn at least a portion of the output light passing therethrough into the light-turning layer;
measuring a signal indicative of the color of light incident upon at least one color sensor of the display device, wherein the at least one color sensor is in optical communication with the light-turning layer; and
comparing the measured signal to a second signal to provide an indication of whether an actual color output by the at least one display element in response to the first driving condition is different from the first color.

19. The computer-readable storage medium of claim 18, further including recalibrating the first driving condition based on the comparison between the measured signal and the second signal, wherein the second signal corresponds to an intended output light of the analog display element.

20. The computer-readable storage medium of claim 18, further including:
applying a second driving condition to the analog display element, wherein the second driving condition is configured to place the analog display element in a reference state in which the analog display element outputs a reference color which remains substantially constant over the lifetime of the analog display element; and
measuring a reference signal indicative of the color of light incident upon the at least one color sensor during application of the second driving condition to provide an indication of the effect of ambient lighting conditions on the signals measured by the color sensor.
